(19) United States
(12) Patent Application Publication
(10) Pub. No.: US 2019/0063479 A1
(43) Pub. Date: Feb. 28, 2019

(54) Double Sided Fastening Device

(71) Applicant: Pierre Eisenmann, Cagnes sur Mer (FR)

(72) Inventor: Pierre Eisenmann, Cagnes sur Mer (FR)

(21) Appl. No.: 16/114,164

(22) Filed: Aug. 27, 2018

Related U.S. Application Data
(60) Provisional application No. 62/550,664, filed on Aug. 27, 2017.

(51) Int. Cl. F16B 15/00

(52) U.S. Cl. CPC F16B 15/0007

(57) ABSTRACT

An elongate double sided construction fastener having a first end and a second end separated by at least one flange, and the first end and second end can be nails, screws, or any other fastener, the same or different.

### CLAIM OF PRIORITY

This patent application claims priority under 35 USC 119 (e) (1) from U.S. Provisional Patent Application Ser. No. 62/550,664 filed Aug. 27, 2017, of common inventorship herewith entitled, “Invisible Nail,” which is incorporated herein by reference as though the same were set forth in its entirety.

### FIELD OF THE INVENTION

The present invention pertains to the field of construction nails, and more specifically to the field of double sided construction nails featuring sharpened points on each end.

### BACKGROUND OF THE INVENTION

Every day, thousands of professional contractors and amateur do-it-yourselfers embark on a variety of construction and home improvement tasks such as building an addition onto the home, replacing paneling or flooring and installing cupboards and countertops. Requiring varying degrees of skill, as well as a good eye, the results achieved by successfully completing these tasks can be enjoyed for years. Regardless of whether one is a professional contractor, or simply a husband and wife duo making improvements to their living space, most would agree that the most important element in the completion of any of these tasks are tools. Hammers, chisels, saws, and screwdrivers are but a few of the manual tools that are invaluable to anyone involved in construction or home improvement tasks. In addition, electric or battery powered tools such as drills, sanders and nail guns can make a variety tasks easier.

The prior art has put forth several designs for construction nails. Among these are.

U.S. Pat. No. 5,743,693 to Edmond P. Sobotker, Jr. provides a double-ended nail driving system for securing two boards together without scarring a surface of the boards by securing a conventional fastener into the surface of the boards. The device includes a double-ended nail having a center flange, an elongated cylinder having an elongated cavity projecting into an end for removably receiving an end of the double-ended nail, and a lower flange attached to the end for engaging the center flange of the double-ended nail. The lower flange engages the center flange thereby allowing the user to tap upon an opposite end with a conventional hammer thereby penetrating the double-ended nail into the board within dulling a sharpened end of the double-ended nail.

U.S. Pat. No. 8,551,137 to Matthew Cohen provides a threaded tissue tack for use in approximating and securing a pair of tissue sections together. The threaded tissue tack has a central body portion and first and second screws extending from opposite ends of the central body portion. The first screw includes a left-hand thread and the second includes a right-hand thread. Engagement structure is provided on the central body portion to rotate the threaded tissue tack about its longitudinal axis and into the pair of tissue sections. There is also disclosed a tack driver for rotating the threaded tissue tack into the tissue. Guards are provided intermediate first and second ends of the central body portion and the first and second screws to protect surrounding tissue from the tack driver.

U.S. Pat. No. 5,165,588 to Donald S. Rowland provides a nail driver apparatus and a nail directed to joining abutting wood members with headless opposing points nails has a driver and opposing points nail for driving a blind or concealed nail. The driver apparatus includes a preferred means for driving and guiding a headless opposing points fastener by means of a percussive driving force, such as a hammer blow to a shaft member, and for protecting a point of the nail or fastener inserted into the driver.

None of these prior art references describe the present invention.

### SUMMARY OF THE INVENTION

It is an object of the present invention to provide an elongate double sided construction fastener having a first end and a second end wherein the first end and the second end are capable of penetrating material to be fastened, wherein the first end and second end are separated by a flange.

It is a further object of the present invention to provide a double sided construction fastener having a first end and a second end wherein the first end terminates in a sharpened point and the second end terminates in a sharpened point.

It is a still further object of the present invention to provide a double sided fastener having a first end terminating in a nail and a second end terminating in a nail.

It is a still further object of the present invention to provide a double sided construction fastener wherein the size of the first end nail and the size of the second end nail is the same.

It is a still further object of the present invention to provide a double sided construction fastener wherein the size of the first end nail and the size of the second end nail is different.

It is a still further object of the present invention to provide a double sided construction fastener wherein the first end is a nail and the second end is a screw.

It is a still further object of the present invention to provide a double sided construction fastener wherein the flange is in the shape of a hexagon.

It is a still further object of the present invention to provide an applicator tool suitable for driving the first end of the fastener into the material to be fastened, wherein one end of the fastener is a nail.

It is a still further object of the present invention to provide an applicator tool suitable for driving the first end of the fastener into the material to be fastened, wherein one end of the fastener is a screw.

It is a still further object of the present invention to provide an applicator tool suitable for driving the first end of the fastener into the material to be fastened, wherein one end of the fastener is a hexagonal nut.

### BRIEF DESCRIPTION OF THE DRAWINGS

FIG. 1 is a front perspective view illustrating a double sided fastening device, having a nail at each end, constructed in accordance with the present invention, wherein the first end and second end are separated by a single flange which functions as the head of the nails.

FIG. 2 is a front perspective view illustrating a double sided fastening device, having a nail at the first end and a screw at the second end, constructed in accordance with the present invention, wherein the first end and second end are separated by a single flange which functions as the head of the nail or screw.

FIG. 3 is a front perspective view illustrating a double sided fastening device, having a nail at each end constructed in accordance with the present invention, wherein the first end and second end are separated by two flanges which functions as the head of the nails.

FIG. 4 is a front perspective view of the cylindrical tool useful for driving or screwing the first side of the fastening device into the material being fastened.

FIG. 5 is a front perspective view illustrating a double sided fastening device, having a push pin at each end, constructed in accordance with the present invention, wherein the first end and second end are separated by a single flange which functions as the head of the push pins.

FIG. 6 is a front perspective view of the cylindrical tool useful for driving or screwing the first side of the fastening device into the material being fastened, wherein the flange is in the form of hexagon, suitable for receiving or otherwise engaging with a wrench for inserting or removing the fastener.

FIG. 7 is a front perspective view of an elongate two-tined fork tool useful for screwing the first side of the fastening device into the material being fastened, wherein the flange comprises two slots or notches on opposite sides of the circumference of the flange, wherein the notches or slots are suitable for engaging with the tines of the fork to permit rotation of the fastener for inserting or removing the fastener.

FIG. 8 is a close-up view of the approaching engagement of the two-tined fork tool shown in FIG. 7 into the slots of the flange of the fastener.

### DETAILED DESCRIPTION OF THE INVENTION

Please refer to the drawings. The present invention is a double sided fastening device 10, also referred to as double sided fastener, or elongate double sided construction fastener, and also referred to as “Invisible Nail” provides a modified line of elongate construction fasteners having material engaging means or sharpened points on each end. In this manner, the Invisible Nail offers a more efficient and neater means of connecting items together, without the nail or screw being exposed. This augmentation concept could be applied to virtually any type of nails, screws, bolts, pins, or other fasteners, including aluminum nails, box nails, tacks, casing nails, convex nails, and copper nails, brass screws, steel screws, aluminum screws, and in all lengths (such as 25 mm to 152 mm). As an additional consideration, the dual sides can present different nail types; one end can feature a standard nail tip, while the opposite can provide a screw.

In an embodiment shown in FIG. 1, a double sided fastener comprises a first end 12 and a second end 14, wherein the first end and second end are capable of penetrating material to be fastened, and the first end and the second ends are separated by at least one circumferential flange 16, which flange 16 is positioned approximately equidistant from the first end and the second end of the fastener and serves as the joining point when fastening two objects, such as two boards. It is important to note that flange 16 can be of any diameter and thickness, according to design requirements of the situation.

In the embodiment shown in FIG. 1, both the first end 12 and second end 14 comprise nail heads. A specialized tool 20, shown in FIG. 4, is provided for nail application. Tool 20 comprises a cylinder 26 having an opening 27 at the base 28 and a closed end 29 at the top 25. Opening 27 is capable of receiving the first end 12 of the fastening device 10. The tool facilitates effortless application of the first side 12 of the fastening device into the material to be fastened by placing the cylinder 26 over the second side 14 of the fastening device 10, and striking the closed end 29 of the tool 20 with sufficient impact to drive the first side 12 of the fastening device 10 into the material to be fastened. Tool 20 provides use of the fastener 10 without the need to strike the exposed point of the second side 14 nail with a hammer; as the second end 14 of the fastening device 10 is ensconced within the tool 20, a hammer is used on the closed end 29 of the tool 20. Once the first side 12 of the fastener 10 has been inserted into the material to be fastened, the second object piece of material is placed on top of the exposed second end 14 of the fastener, and joined accordingly.

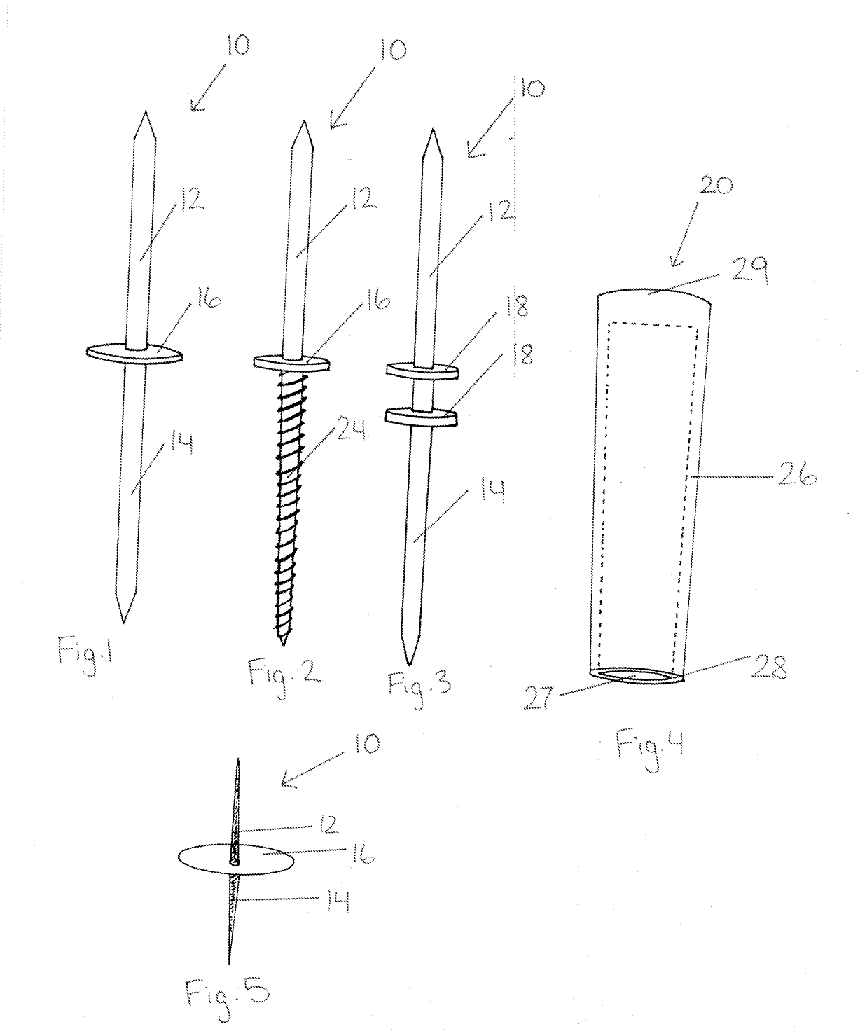

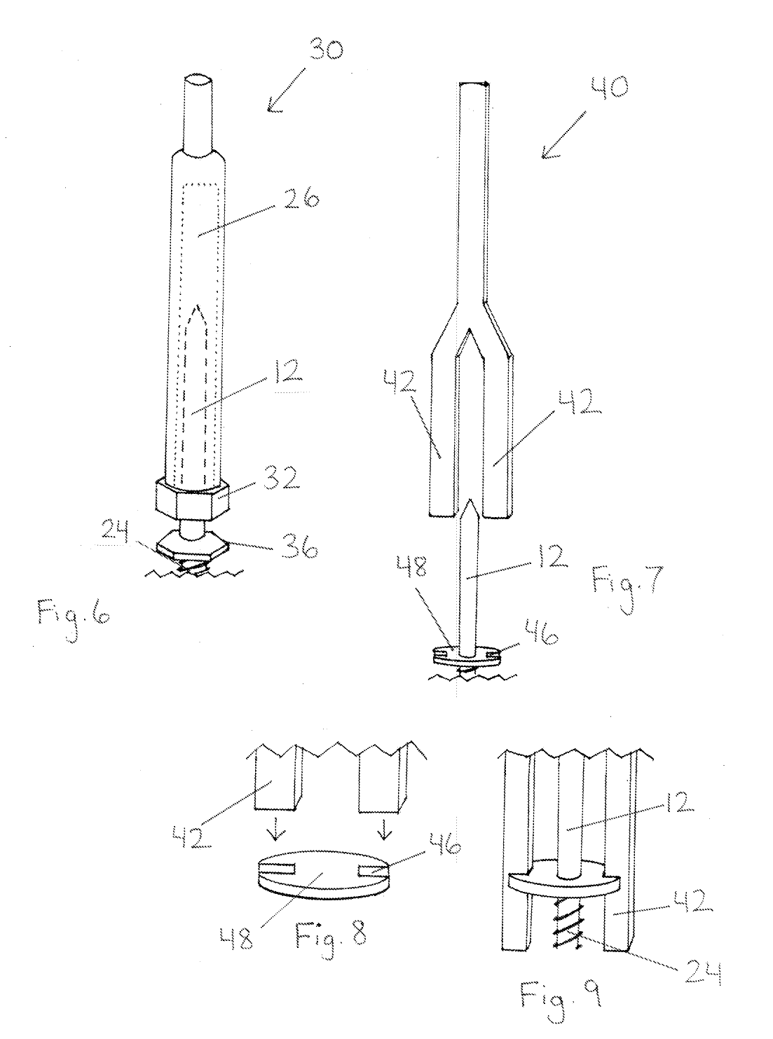

In an embodiment where one end of the fastener is a screw, the flange will have two notches, equally spaced along the circumference of the flange for engagement with tines of a tool suitable for use in inserting or removing the screw. In this alternative embodiment shown in FIG. 2, the invention comprises a double sided fastening device wherein the first end 12 comprises a nail head and the second end 24 comprises a screw. In this situation a specialized tool, shown in FIG. 7 is employed to drive the screw into the material to be fastened. The tines 42 of tool 40 engage with notches 46 positioned on opposite sides of flange 48. Engagement of tines 42 with flange 48 permit rotation to the fastening device to thereby drive the screw into the material. Close-up views showing the engagement of tines 42 with notches 46 of flange 48 are shown in FIGS. 8 and 9.

In a further alternative embodiment shown in FIG. 6, a cylindrical tool useful for driving or screwing the first side of the fastening device into the material being fastened, wherein the flange is in the form of hexagon, and one end of the fastener is a bolt, wherein the flange is suitable for receiving or otherwise engaging with a wrench for inserting or removing the fastener.

In a still further embodiment, a dual sided push pin is shown in FIG. 5, Pushpin shown in FIG. 5, comprises first end 12, second end 14 and flange 16.

The Invisible Nail can be used for both temporary and permanent applications, and can also be applied using a nail gun. Invisible Nail's push pins can also be used when mounting ready-to-assemble furniture, instead of mortise and tenon joints.

Eliminating the unsightly view of exposed nails, the Invisible Nail enables users to execute a variety of tasks, leaving behind a project that is pristine and unblemished. An important advantage is that the Invisible Nails are very useful when building or repairing walk-boards. Because the nails are hidden under the board, the nail head will never pop-out of the board, injuring the toes or the bottom of the feet. There is also the possibility of having a gap between two fixed pieces by using a “two flanged nail”, or by using a “tube” (plastic, metal, or other) that can be cut at any length to make a gap between two fixed pieces.

The Invisible Nail offers a number of significant benefits and advantages, Foremost, the Invisible Nail provides a simpler, more user friendly way in which to complete a wide variety of nail-related tasks. A line of modified construction-grade fasteners with sharpened points at each end, the Invisible Nail readily adapts to both simple and complicated endeavors. Eliminating the unsightly view of exposed nails, the Invisible Nail enable users to execute a variety of tasks, leaving behind a project that is pristine and unblemished. Whether one is building a model, assembling a desk, or hanging joists, this universal and versatile product is the go-to hardware system for a virtually limitless number of jobs. Durably constructed, the Invisible Nail will withstand years of repeated use, with ease.

The Invisible Nail offers a new and exciting addition to the tools and hardware market. Multifunctional, the Invisible nail can be readily applied in the home or on construction sites.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An elongate double sided construction fastener having a first end and a second end wherein the first end is capable of penetrating material to be fastened and the second end is capable of penetrating material to be fastened, wherein the first end and second end are separated by at least one flange.

2. The elongate double sided construction fastener of claim 1, wherein the first end terminates in a sharpened point and the second end terminates in a sharpened point.

3. The elongate double sided construction fastener of claim 2, wherein the first end is a nail and the second end is a nail.

4. The elongate double sided construction fastener of claim 3, wherein the size of the first end nail and the size of the second end nail is the same.

5. The elongate double sided construction fastener of claim 3 wherein the size of the first end nail and the size of the second end nail is different.

6. The elongate double sided construction fastener of claim 2 wherein the first end is a nail and the second end is a screw, and the flange has two notches equally spaced on the circumference of the flange.

7. The elongate double sided construction fastener of claim 1, wherein the flange is in the shape of a hexagon.

8. The elongate double sided construction fastener of claim 2, wherein the first end is a pushpin and the second end is a pushpin.

9. An applicator tool for driving a first end of a double sided construction fastener into material to be fastened, wherein at least one end of the fastener is a nail, the tool comprising an elongate cylinder having an opening at the base of the cylinder capable of receiving the first end of a double sided construction fastener and a closed end at the top of the cylinder, wherein the closed end is capable of being struck with sufficient force to drive the nail end into the material to be fastened, wherein at least one end of the double sided construction fastener is a nail.

10. An applicator tool for driving a first end of a double sided construction fastener into material to be fastened wherein one end of the fastener is a screw, the fastener further having a notched flange and the applicator comprises a two tined fork wherein the tines of the fork are capable of engaging with the notches on the flange enabling rotation and thereby insertion or removal of the screw.

11. The double sided construction fastener of claim 1 wherein the position of the flange is equidistant between the first end and the second end.

12. The double sided construction fastener of claim 1 having two flanges.

13. The double sided construction fastener of claim 12, having space between the two flanges, wherein the distance of the space is determined by the function of the design.

14. The double sided construction fastener of claim 1, wherein the first end is selected from the group consisting of: nails, screws, bolts, pins, aluminum nails, box nails, tacks, casing nails, convex nails, and copper nails, brass screws, steel screws, and aluminum screws.

15. The double sided construction fastener of claim 1, wherein the length is in the range from approximately 25 mm to 152 mm.

16. The double sided construction fastener of claim 1, wherein the first end is selected from the group consisting of: nails, screws, bolts, pins, aluminum nails, box nails, tacks, casing nails, convex nails, and copper nails, brass screws, steel screws, and aluminum screws.

17. The double sided construction fastener of claim 1, wherein the length is in the range from approximately 25 mm to 152 mm.
